(19) United States
(12) Patent Application Publication
(10) Pub. No.: US 2006/0156024 A1
(43) Pub. Date: Jul. 13, 2006

(54) Systems and methods for disk drive access under changes in environmental parameters

(75) Inventors: Fernando Zayas, Loveland, CO (US); Mine Budiman, Livermore, CA (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Osaka (JP)

(21) Appl. No.: 11/261,031

(22) Filed: Oct. 28, 2005

Related U.S. Application Data
(60) Provisional application No. 60/623,270, filed on Oct. 29, 2004.

(51) Int. Cl. H04L 9/00; H04K 1/00

(52) U.S. Cl. 713/182

(57) ABSTRACT

The present invention provides novel approaches to control access to hard disk drive based on surrounding environments. It first detects one or more environmental parameters surrounding the drive and/or an appliance, then blocks access to the drive when one or more conditions are unfavorable. This description is not intended to be a complete description of, or limit the scope of, the invention. Other features, aspects, and objects of the invention can be obtained from a review of the specification, the figures, and the claims.

### CLAIM OF PRIORITY

This application claims priority from the following co-pending applications, which are hereby incorporated in their entirety:

U.S. Provisional Application No. 60/623,270 entitled DISK DRIVE ACCESS UNDER CHANGES IN ENVIRONMENTAL PARAMETERS, by Fernando Zayas et al., filed Oct. 29, 2004 (Attorney Docket No. PANAP-01165US0).

### FIELD OF THE INVENTION

The present invention relates to the access to a storage device.

### BACKGROUND

Traditionally, a storage device such as a hard disk drive or an optical storage is associated with a computing device, which may include, but is not limited to, a laptop or desktop PC, a workstation, and a mainframe computer. As storage devices become higher in density and more compact in size, they are increasingly integrated and/or embedded in portable/mobile electronic devices/appliances/hosts, which may include, but are not limited to, cell phones, PDAs, Tablet PCs, Pocket PCs, MP3 players, iPods, electronic messaging devices, and Java-enabled devices. Here, a storage device can be, but is not limited to, an external storage device, a portable storage device, a wireless storage device, a Bluetooth storage device, or an internal storage device on a resource-rich computing device. Due to its expanded applications, a storage device may subject to various environmental conditions (factors/parameters) under which its embedded appliance may be operating. Such environmental parameters may include but are not limited to, temperature, pressure, humidity, air/gas condition, electric/mechanical shock, vibration, and electronic interference. Due to its electrical, mechanical, or magnetic nature, a storage device may not be able to perform certain requested operations if one or more of the environmental parameters become unfavorable. By a non-limiting example, a storage device embedded in mobile appliances may not be operating properly outside of a range of temperatures. When the temperature is too cold, it may become too “hard” to write, read or even spin up because the lubricants in the motor are too thick. Therefore, it is important that a storage device should be able to adopt measures to protect itself and/or the data stored in it under extreme environmental parameters.

### BRIEF DESCRIPTION OF THE DRAWINGS

FIG. 1 is a diagram showing components of an exemplary system that can be used in accordance with various embodiments of the present invention.

FIG. 2 is a flowchart showing a process that can be used with the system of FIG. 1.

FIG. 3 is a flowchart showing a process that can be used with the system of FIG. 1.

FIG. 4 is a diagram showing components of an exemplary system that can be used in accordance with various embodiments of the present invention.

FIG. 5 is a flowchart showing a process that can be used with the system of FIG. 4.

### DETAILED DESCRIPTION

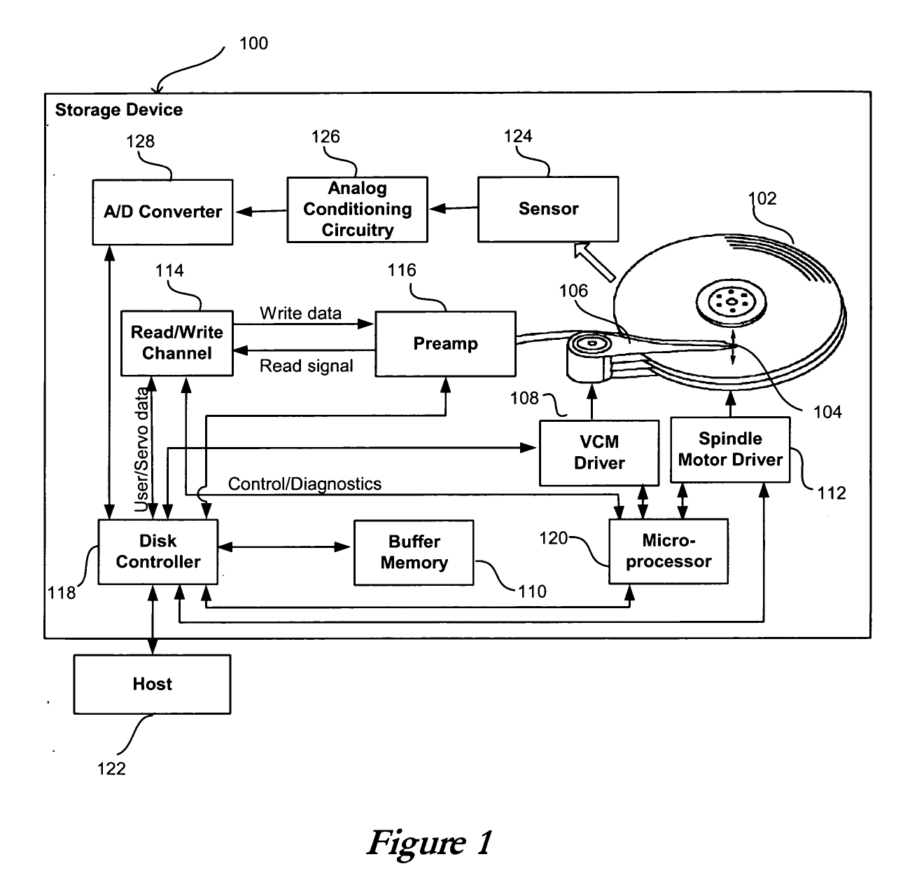

An exemplary hard disk drive 100, as shown in FIG. 1, includes at least one magnetic disk 102 capable of storing information on at least one of the surfaces of the disk. A closed-loop servo system can be used to move an actuator arm 106 and data head 104 over the surface of the disk, such that information can be written to, and read from, the surface of the disk. The closed-loop servo system can contain, for example, a voice coil motor driver 108 to drive current through a voice coil motor (not shown) in order to drive the actuator arm, a spindle motor driver 112 to drive current through a spindle motor (not shown) in order to rotate the disk(s), a microprocessor 120 to control the motors, and a disk controller 118 to transfer information between the microprocessor, buffer memory 110, read/write channel 114, and a host 122. A host can be any device, apparatus, or system capable of utilizing the data storage device, such as a personal computer or Web server or consumer electronics device. The drive can contain at least one processor, or microprocessor 120, that can process information for the disk controller 118, read/write channel 114, VCM driver 108, or spindle driver 112. The microprocessor can also include a servo controller, which can exist as an algorithm resident in the microprocessor 120. The disk controller 118, which can store information in buffer memory 110 resident in the drive, can also provide user data to a read/write channel 114, which can send data signals to a current amplifier or preamp 116 to be written to the disk(s) 102, and can send servo and/or user data signals back to the disk controller 118.

A hard disk drive used in accordance with various embodiments of the present invention may optionally further include at least one sensor 124, capable of detecting and measuring various environmental parameters mentioned above. The output from the sensor may be conditioned-filtered and/or amplified by an analog conditioning circuitry 126, before output to an A/D converter 128 capable of converting an analog signal to a digital signal automatically or upon a “convert” request. The digital signal can then be optionally filtered digitally before being provided to the disk controller 118 and stored in a register. The analog conditioning circuitry 126 shown in FIG. 1 can be as simple as a linear amplifier, or it could be a low-pass, high-pass, or band-pass filter, or even a complex non-linear processing circuit (by way of non-limiting examples, such as a signal-squared, sum-of-squares of multiple signals, square-root, sine, cosine, arc-sine, exponential, etc). The analog conditioning circuitry could even be absent, in which case the signal from the sensor would go directly to the A/D converter 128. The A/D converter 128 shown in FIG. 1 might provide any number of bits of resolution, from 16 or more bits, down to a single bit (in the latter case, effectively comparing the signal to a specified level).

Note that although analog conditioning circuitry and the A/D converter are shown as discrete components in the diagram, they may practically be embedded in the preamp 116, read/write channel 114, VCM Driver 108, Spindle Driver 112, or even in the Disk Controller 118, respectively. The digital filter and the register for the output from the A/D converter are not shown in the diagram since they are typically embedded in one or more of the rest of the components, such as disk controller and micro-processor.

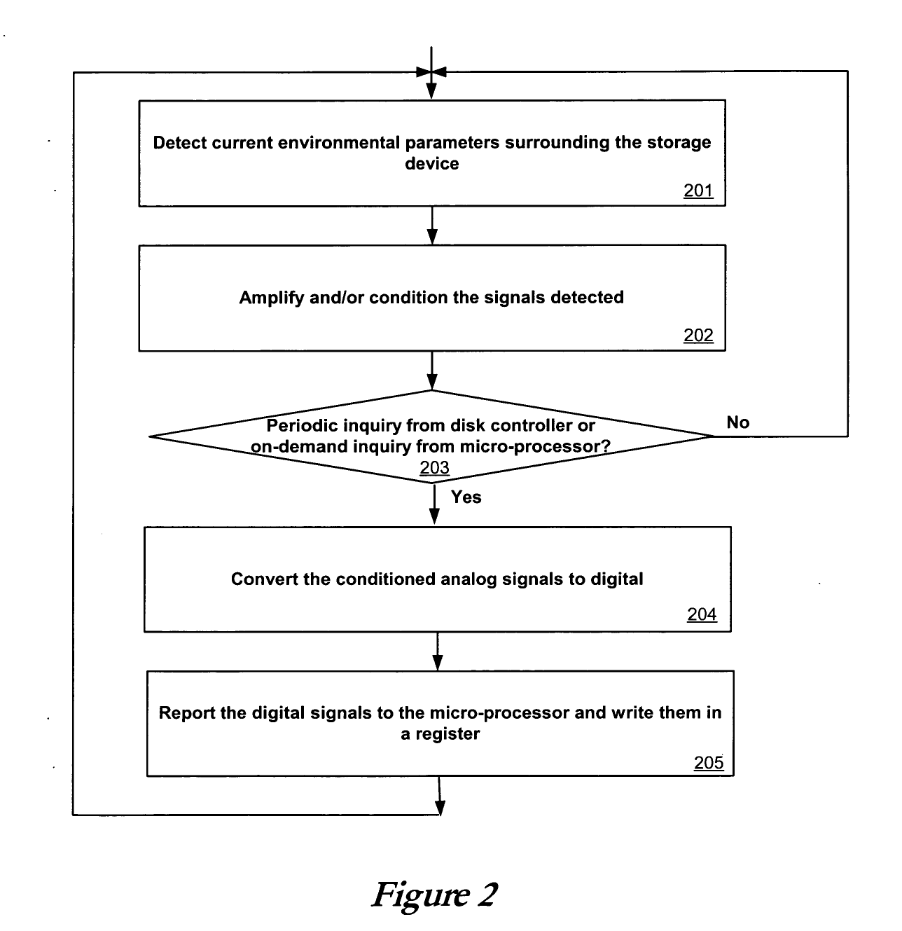

An exemplary environmental parameter detecting and recording approach is shown by the process in FIG. 2. At step 201, one or more sensors of the storage device may detect and measure the current values of various environmental parameters surrounding the storage device. The generated analog signal may then be amplified and/or filtered at step 202 before output to an A/D converter. The A/D converter may convert the conditioned analog signal to a digital one at step 204 automatically or wait for a converting signal from the disk controller. Here, the converting signal may be initiated by the disk controller periodically or by the on-demand request from the micro-processor (when it is to process the latest digital signal from the sensor) through the disk controller at step 203. Finally, the converted digital signal is stored in a register and/or reported to the micro-processor at step 205 either directly or via to the disk controller.

In some embodiments of the present invention, the storage device may keep a lookup table of acceptable ranges of various environmental parameters corresponding to a series of possible operations to access the storage device requested by the host. The storage device may refuse to perform an operation requested when the value of at least one of the environmental parameters is out of the range required for the operation. By a non-limiting example, the storage device can refuse to operate if the temperature is too hot or too cold. Further, read and write operations can be rejected at different temperature ranges. In addition, the storage device can report the temperature it measures in degrees Centigrade, and report the reason why the requested operation is not performed. In one embodiment, bits in a status register can be reserved to report temperature too high or too low and a register can be utilized to report the (signed) temperature in degrees Centigrade.

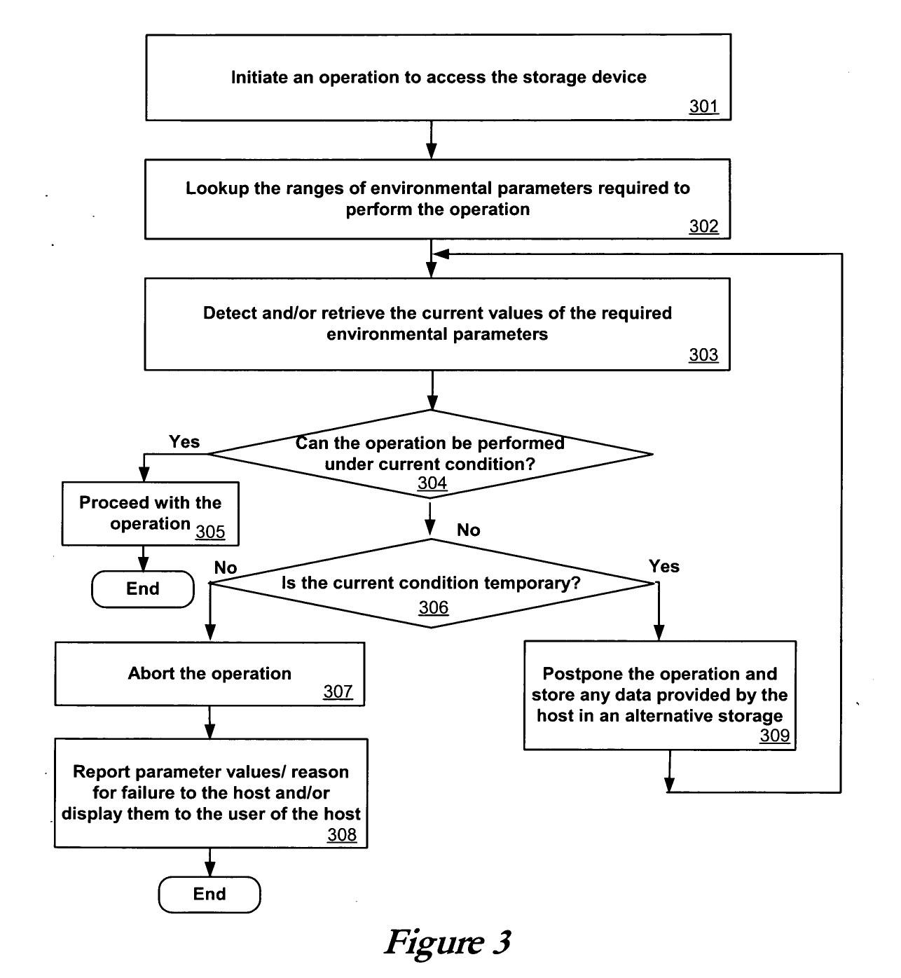

An exemplary storage device self-protection approach is shown by the process in FIG. 3. At step 301, the host initiates an operation to access the storage device. The micro-processor in the storage device receives the request via disk controller and lookups the acceptable ranges of environmental parameters for the requested operation at step 302. It may then issue a converting instruction to the A/D converter and retrieve the current values of the environmental parameters surrounding the storage device at step 303. If it determines that the operation can be performed under the current values of the environmental parameters at step 304, the storage device will then proceed to perform the requested operation at step 305. Otherwise, the storage device needs to determine if the current unfavorable conditions might be temporary, for example, by keeping a timer and setting a timeout limit of the condition at step 306. If the situation has not improved for a prolonged period of time, the requested operation will be aborted at step 307. The storage device may then notify/report to the host the reason of the failure of the operation and/or the values of the environmental parameters and (optionally) the host may display such information to its users at step 308. If the situation is regarded as temporary, the operation will be paused and data (if any) to be written to the storage device may be stored in an alternative storage device at step 309, wherein the alternative storage device can be, but is not limited to, a RAM, a flash, and other volatile or non-volatile storage device associated with the storage device or on the host. Even if the drive aborts an operation and reports it to the host, the host may decide to re-try the operation later.

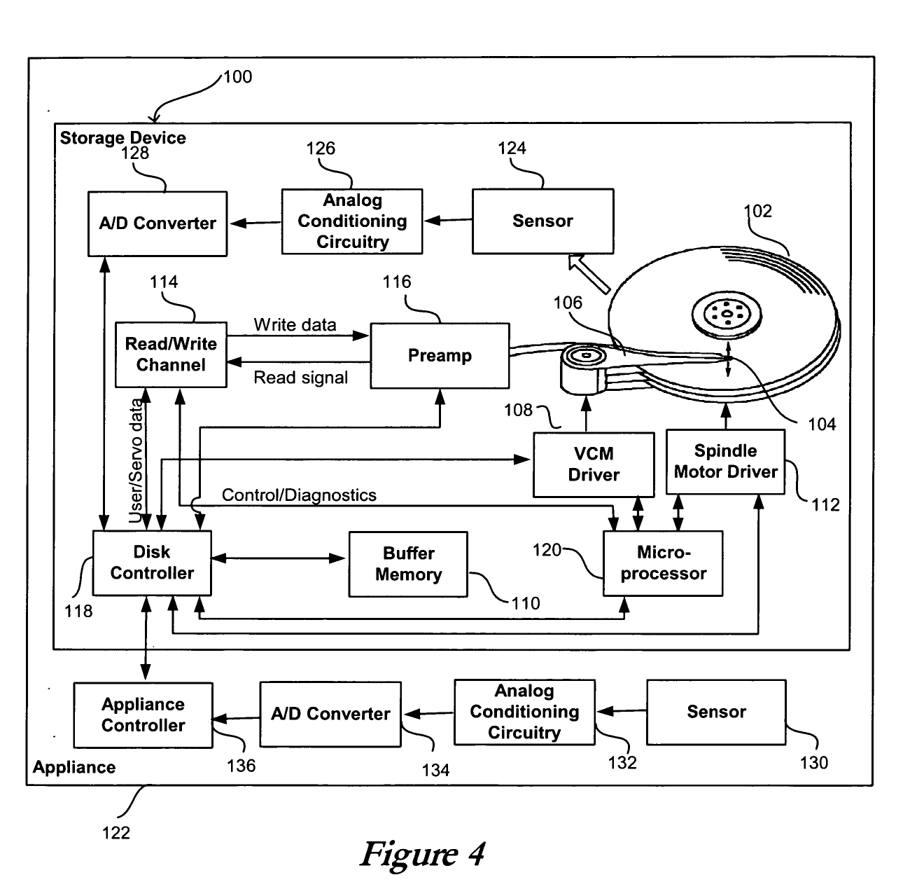

An exemplary hard disk drive 100 embedded in an appliance 122, such as a cell phone, is shown in FIG. 4. Compared to the storage device in FIG. 1, such an appliance may also include an optional sensor 130 capable of detecting a change the surrounding environmental parameters as well as the sudden movement of the appliance. Such a sensor can be, but is not limited to, a temperature sensor, a pressure sensor, a humidity sensor, a air/gas sensor, a noise/sound sensor, a electronic interference sensor, and a 3-axis accelerometer capable of sensing the acceleration of the appliance. In addition, the appliance may also include an analog conditioning circuitry 132 to process the analog signal detected by the sensor and an A/D converter 134 to convert the analog signal to digital and output it to the an appliance controller 136, which will communicate with the storage device.

In various embodiments of the present invention, an appliance having an internal (embedded) storage device is able to inform the storage device of changes in the environment parameters and/or coming or ongoing events/operations to be performed by the appliance, which the storage device may not be aware of. As an non-limiting example, a cell phone may inform an embedded storage device that the phone is about to perform one of the following: speaking, vibrating, transmitting at high power, and transmitting at low power, or that battery charge is low, battery charge is critical, or that it has detected the fact that it is moving suddenly (e.g. falling) and may soon experience an extreme shock. It may then block write, read, or even track following operation on the storage device for the time being.

The appliance, in response to environmental or other conditions that cause a desired operation to the storage device to not take place, either by internally detected or storage device reported means, may also notify the user of the failure and provide an indication of what conditions need to be corrected that would allow the operation to succeed at some future time. As a not-limiting example, a wireless personal video player can notify the user that the recording of a scheduled news broadcast has failed due to high temperature, perhaps because the appliance is in a closed automobile in the sunshine.

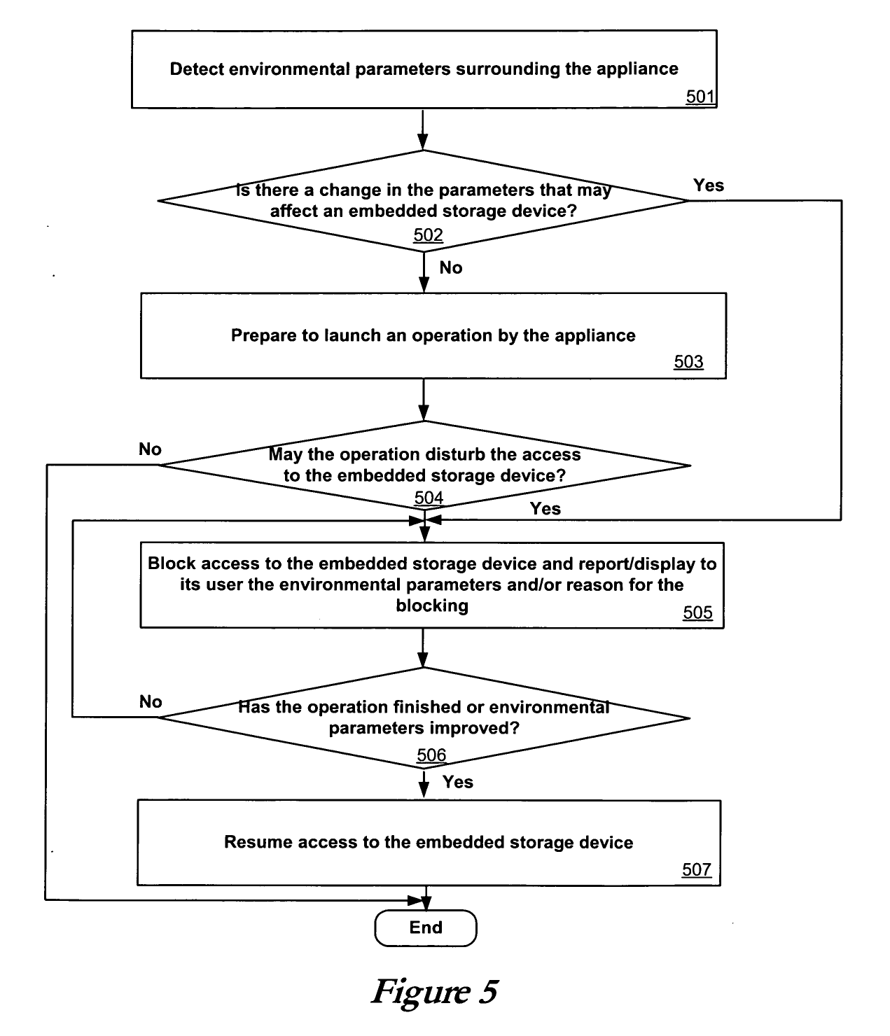

An exemplary notification process by the appliance is shown in FIG. 5. At step 501, one or more sensors in the appliance may detect and measure the current values of the various environmental parameters surrounding the appliance. If it is determined at step 502 that a change in the value of an environmental parameter may affect the access to an embedded storage device, the appliance may block write or read access to the embedded storage device at step 505 and may optionally report and/or display to its user the values of the environmental parameters as well as the reason for blocking the access. Otherwise, the appliance may prepare to launch an operation such as transmitting at high power or vibrating at step 503. If it is determined that such operation may disturb the access to the storage device at step 504, the access to the storage device will also be blocked at step 505. Once it is determined that the environmental conditions have improved or the appliance operation has finished at step 506, access to the embedded storage device may resume at step 507. Otherwise, the blockage will continue.

Table 1 show an exemplary register utilized by the appliance to notify the storage device of changes in environmental conditions that may affect the storage device.

TABLE 1
Configuration R/W

| | | | | | | | |
|---|---|---|---|---|---|---|---|
| 7 | 6 | 5 | 4 | 3 | 2 | 1 | 0 |

| | | | |
|---|---|---|---|
| Reserved | CMD Abort | Env Attn | Power down |

In the configuration register shown in Table 1, Bit 1 (Env Attn) is utilized to inform the storage device of environmental condition changes. Before setting this bit, the appliance should set or clear bits in register for environment conditions shown later in Table 2 that indicate that the storage device is allowed to write or allowed to track follow (i.e., have heads over the media) and read. Bit 0 (Power down) is a notification by the appliance to the storage device that power is going away. In response to setting this bit, the storage device will stop any pending writes to the media within a short period of time, in one example 200 us or less.

In some embodiments, a register that includes many bits may be utilized to inform the storage device that certain operations or environment changes have or will occur. A “door bell” may cause an interrupt to the micro-processor on the storage device so that the storage device will act on the information of the coming events.

TABLE 2
Environment Conditions <7:0> R/W

| | | | | | | | |
|---|---|---|---|---|---|---|---|
| 7 | 6 | 5 | 4 | 3 | 2 | 1 | 0 |

| | |
|---|---|
| Inhibit track | Inhibit write |
| follow conditions | conditions |

The exemplary register shown in Table 2 can be used by the appliance to report environment conditions to the storage device. The bits are not assigned meanings, since these will vary from appliance to appliance.

If environmental conditions exist that should prevent the storage device from writing, any of the bits <3:0> should be set. If any environmental conditions exist that should prevent the storage device from track following, any bit in bits <7:4> should be set to prevent the storage device from having the heads over the media.

Changes in this register should be followed by setting bit 1 in the configuration register discussed earlier. This will interrupt the micro-processor of the storage device so that the changes can be acted upon. Inhibit write conditions should take effect within a very short time (say, 200 us for example). Compliance with inhibit track follow conditions will likely take longer (say, 250 ms for example).

As non-limiting examples: Bit 0 of this register could indicate that the appliance will shortly be vibrating or transmitting at high power and the storage device should not attempt to write at this time. Bit 7 of this register could indicate that the appliance has been dropped and that the heads should be retracted from the media to their parking position prior to impact.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

What is claimed is:

1. A system to support environment-aware storage access, comprising:
a host operable to access the information stored in a storage device; and
said storage device operable to perform at least one of:
storing information on a media; and
blocking access to the storage device if one or more detected environmental parameters are unfavorable.

2. A system according to claim 1, wherein:
the host can be one of a laptop or desktop PC, a workstation, and a mainframe computer.

3. A system according to claim 1, wherein:
the storage device can be one of an external storage device, a portable storage device, a wireless storage device, a Bluetooth storage device, and an internal storage device on a resource-rich computing device.

4. A system according to claim 1, wherein:
each of the one or more detected environmental parameters can be one of temperature, pressure, humidity, air/gas condition, electric/mechanical shock, vibration, and electronic interference.

5. A system according to claim 1, further comprising:
one or more of the following components embedded in the storage device:
a sensor operable to detect values of the one or more environmental parameters surrounding the storage device;
an analog conditioning circuitry operable to filter and/or amplify the values detected; and
an A/D converter operable to perform at least one of:
converting an analog signal from the analog conditioning circuitry to a digital signal;
storing the digital signal in a register in the storage device; and
providing the digital signal to a micro-processor in the storage device.

6. A system according to claim 5, wherein:
the analog conditioning circuitry can be one of a linear amplifier, a low-pass filter, a high-pass filter, a band-pass filter, and a complex non-linear processing circuit.

7. A system to support environment-aware storage access, comprising:
a storage device embedded in an appliance and operable to store information on a media; and
said appliance operable to perform at least one of:
reading and/or writing the information stored in the embedded storage device;
notifying and/or displaying the information to an user of the appliance; and
blocking access to the storage device based on one or more conditions.

8. A system according to claim 7, wherein:
the appliance can be one of a cell phone, a PDA, a Tablet PC, a Pocket PC, a MP3 player, an iPod, an electronic messaging device, and a Java-enabled device.

9. A system according to claim 7, further comprising:
one or more of the following components embedded in the appliance:
a sensor operable to detect values of one or more environmental parameters surrounding the storage device;
an analog conditioning circuitry operable to process the values detected; and
an A/D converter operable to convert the values from analog to digital.

10. A system according to claim 9, wherein:
the sensor can be one of a temperature sensor, a pressure sensor, a humidity sensor, a air/gas sensor, a noise/sound sensor, a electronic interference sensor, and a 3-axis accelerometer capable of sensing the acceleration of the appliance.

11. A method to support environment-aware storage access, comprising:
storing information on a storage device;
measuring values of one or more environmental parameters surrounding the storage device; and
blocking access to the storage device if one or more detected environmental parameters are unfavorable.

12. A method according to claim 11, further comprising:
filtering and/or amplifying the values of the one or more environmental parameters;
converting the values of the one or more environmental parameters from analog to digital either automatically or upon a converting signal from the storage device;
storing the digital values of the one or more environmental parameters in a register in the storage device; and
providing the digital values to a micro-processor in the storage device.

13. A method to support environment-aware storage access, comprising:
preparing to launch an operation by an appliance;
detecting and measuring values of one or more environmental parameters surrounding the appliance;
blocking access to a storage device embedded in the appliance under one or more conditions.

14. A method according to claim 13, wherein:
the operation can be a read/write access to the storage device.

15. A method according to claim 13, wherein:
the operation can be one of transmitting at high power and vibrating.

16. A method according to claim 15, wherein:
one of the one or more conditions can be that the operation can disturb the access to the storage device.

17. A method according to claim 13, further comprising at least one of:
reporting the failure of the operation to a user of the appliance; and
displaying the values of one or more environmental parameters to the user of the appliance.

18. A method according to claim 13, further comprising:
keeping a lookup table of acceptable ranges of the one or more environmental parameters corresponding to the operation; and
looking up the range of the one or more environmental parameters corresponding to the operation.

19. A method according to claim 18, wherein:
one of the one or more conditions can be that the value of at least one of the one or more environmental parameters is out of the range corresponding to the operation for a period of time.

20. A system to support environment-aware storage access, comprising:
means for storing information on a storage device;
means for measuring values of one or more environmental parameters surrounding the storage device; and
means for blocking access to the storage device if one or more detected environmental parameters are unfavorable.
